(19) United States
(12) Patent Application Publication
(10) Pub. No.: US 2004/0146093 A1
(43) Pub. Date: Jul. 29, 2004

(54) Systems and methods for reducing interference in CDMA systems

(76) Inventors: Eric S. Olson, Boulder, CO (US); Anand P. Narayan, Boulder, CO (US)

Correspondence Address: TENSORCOMM, INC., 1490 W. 121ST AVE., SUITE 105, WESTMINISTER, CO, 80234, US

(21) Appl. No.: 10/699,360

(22) Filed: Oct. 31, 2003

Related U.S. Application Data
(60) Provisional application No. 60/422,476, filed on Oct. 31, 2002.

(51) Int. Cl. H04B 1/707

(52) U.S. Cl. 375/148

(57) ABSTRACT

The systems and methods described herein provide a processing engine useful in a communications receiver. The processing engine substantially reduces interference caused by unwanted signals by mathematically reducing the energy of the signals. In one embodiment, the signals have known CDMA coding schemes. The signals are selectively substantially cancelled using a matrix generated, at least in part, from determined CDMA codes. For example, a receiver of one embodiment includes a demodulator unit for determining a code from each of a plurality of signals and for demodulating one or more of the plurality of signals. The processing engine is communicatively coupled to the demodulator unit and configured for generating a matrix of one or more vectors based on determined codes. Each element of the vectors comprises a component of the determined codes and the matrix itself is used to selectively substantially reduce energy from one or more of the signals.

### CROSS REFERENCE TO RELATED APPLICATIONS

This application claims the benefit of an earlier filing date of previously filed U.S. Provisional Patent Application 60/422,476 (filed Oct. 31, 2002). Additionally, this application is related to commonly owned and co pending U.S. patent application Ser. No. ______ (filed on Oct. 15, 2003; U.S. Provisional Patent Application No. 60/418,187 (filed Oct. 15, 2002)), U.S. patent application Ser. No. 09/988,219 (filed Nov. 19, 2001) and U.S. patent application Ser. No. 10/294,834 (filed Nov. 15, 2002). Each of the above disclosures is hereby incorporated by reference.

### BACKGROUND

1. Field of the Invention

The invention generally relates to the field of communications. More specifically the invention is related to interference suppression for use in Code Division Multiple Access (“CDMA”) communications.

2. Discussion of the Related Art

Interference is a persistent problem in the field of communications. Interference is typically the result of simultaneously receiving multiple signals including the desired signal. Unwanted received signals may corrupt data retrieval processes of desired signals. As communication systems become more complex and data rates increase, the likelihood of signals interfering with one another and even with themselves increases. Examples of such complex communication systems include those of cellular telephony employing CDMA communication signals.

In the cellular telephony example, a cellular telephony system typically includes a plurality of “base stations” located within a geographic region. These base stations communicate with individual mobile units (e.g., radio telephones). For example, a base station produces a coverage “cell” within the cellular telephony system. A mobile telephone communicates with a base station while the mobile telephone is within the cell. As the mobile telephone moves to another cell (i.e., another base station), communications within the original cell may be handed off to the other cell.

Each base station within a cellular telephony system uses an encoded signal to communicate with the mobile telephone. In fact, the cellular telephony system typically uses pseudo random number (PN) codes to encode data signals transmitted to mobile telephones. For example, in cdmaOne and cdma2000 systems, In-phase (I) components and Quadrature (Q) components of data signals are each encoded with a unique PN “short” code. The data signals include digitized voice, data, reference information and/or other types of data. The base station combines the PN code with data to be transmitted at a much faster rate than that of the data. In one CDMA system, cdmaOne, the PN “short” code, is applied to the data at a rate of 1.2288 Mega chips per second with each chip representing a smaller portion of a data element. Such an application of the short code is commonly referred to as direct sequence spreading of the data.

Each base station is assigned a particular timing offset of the short code such that receiving mobile telephone units can determine the identity of a particular base station communicating therewith. Since the base station short codes are shared, the code offset in time distinguishes one base station from another. For example, a mobile telephone unit communicating with a particular base station may be out of reception range with another base station due to distance from the other base station. However, interference can still occur, particularly in regions where cells overlap with one another. This effect is commonly referred to as cross channel interference.

Cross channel interference occurs when a combination of transmitted signals from more than one base station is simultaneously received. Each base station is distinguished by a unique short code offset. The short code sequence has minimal but nonzero cross-correlation properties which manifest as cross channel interference between signals originating from different base stations. Therefore, a signal transmitted by a first base station may interfere with the reception of a signal from a second base station. This cross channel interference can disrupt the intended reception of the second signal due to non-zero cross-correlation of the short code.

Interference caused by other signals transmitted by a base station within a particular cell is substantially mitigated because each signal transmitted within the cell is further encoded with a unique orthogonal code (e.g., a Walsh code) or a unique quasi-orthogonal function (“QOF”) code. Signals broadcast by a base station represent channels of communication between the base station and corresponding mobile telephone units. For example, multiple mobile telephone units may simultaneously communicate with a base station. Moreover, a single mobile telephone may communicate with multiple base stations. Accordingly, the base station transmits multiple CDMA signals to communicate with the telephone units. Most of these CDMA signals represent individual channels conveying digitized voice and/or data between the base station and respective telephone units. However, some channels are broadcast to all telephone units within the cell. One channel is used to convey reference information and to coherently demodulate other channels (e.g., in the form of a pilot signal). Other channels are used to convey paging information and synchronization information that respectively alert a particular mobile telephone unit as to an incoming call and provide synchronization between a mobile unit and a base station.

The base station encodes the data to be transmitted to individual telephone units by applying a covering code to the data. For example, a base station may encode data of each channel with a unique orthogonal Walsh code or with a unique QOF code. Although a particular base station encodes individual channels with a short code at the same offset, the base station provides channelization with Walsh codes or QOF codes that reduces interference caused by the channels transmitted by the particular base station. Walsh codes are known to those skilled in the art.

Either Walsh codes or QOF codes cover data spread by a short code. For example, in a cdmaOne system each bit is spread by a 64 element (“chip”) short code sequence that specifies a broadcasting base station. The resultant chip sequence is further encoded with a 64 chip Walsh covering code.

While these Walsh codes alleviate interference from other signals (i.e., channels) within a cell, interference can still occur due to other radio frequency (RF) phenomena. Particularly, multipath phenomena due to “copies” of a signal traveling different paths can produce co-channel interference. For example, an RF communication signal can reflect off objects and create copies that travel over different paths. These copies can interfere with other copies of the same signals transmitted because they may arrive at a receiver at different times. Walsh codes constitute an orthogonal code set. However, the orthogonality of the Walsh covering codes is essentially lost whenever a time offset exists between two copies of the same signal. Accordingly, misalignment of the codes may result in a high cross-correlation between Walsh codes.

To counter some of the effects of multipath, mobile units of a CDMA cellular telephony system typically use a “rake” receiver to combine two or more received multipath signals to increase the probability of detection. Each “finger” of the rake receiver independently estimates channel gain and carrier phase using the pilot channel to coherently demodulate each of the multipath signals. Symbol estimates are combined in a symbol combiner to provide a better estimate of the transmitted symbols. Rake receivers are known to those skilled in the art.

Typically, rake receiver fingers are assigned to the strongest line-of-sight (“LOS”) or multipath signals in order to provide an improved estimate of transmitted signals. As electromagnetic characteristics of a channel change, the received multipath signals typically change in terms of power relative to one another other. The changes in the channel characteristics can be caused by phenomena such as Rayleigh fading, shadow fading, scattering, diffraction and/or others. The rake receiver fingers combine the strongest set of multipath signals to improve phase estimates and amplitude estimates, among others, of the transmitted signal. As signals change due to such phenomena, fingers are assigned and de-assigned accordingly such that the rake receiver signal set can more accurately demodulate the transmitted signals.

While typical rake receivers are useful in countering the effects of multipath and in fact use multipath to improve signal quality, interference suppression is still an important aspect in the improvement of signal quality. One prior art rake receiver, described in U.S. Pat. No. 6,175,587 (issued Jan. 16, 2001; the “'587 patent”) employs a control device having an interference suppression feature. This interference suppression feature generates a matrix derived from codes of other CDMA signals within a cellular telephony system and uses that matrix to suppress unwanted received signals. However, the interference suppression feature of the '587 patent is inherently inaccurate due to a zero-padding within the matrix generation. This zero-padding alters the direction of the subspace projection and inaccurately suppresses energies of those unwanted received signals. CDMA codes define a code space where all signals can be described as a linear combination of these codes. A subspace projection is a mathematical operation that projects a signal in the code space onto a lower dimensional subspace. As such, the cancellation operation of the '587 patent may degrade signal quality of the desired signal and lead to corruption of the desired signal.

### SUMMARY

The present invention provides a processing engine which may be used in a communications receiver. The processing engine substantially reduces interference caused by unwanted signals by mathematically reducing the energy of the signals. In one embodiment, the signals have known CDMA coding schemes. The signals are selectively substantially cancelled using a matrix generated, at least in part, from determined CDMA codes. For example, a receiver of one embodiment includes a demodulator unit for determining a code from each of a plurality of signals and for demodulating one or more of the plurality of signals. The processing engine is communicatively coupled to the demodulator unit and configured for generating a matrix of one or more vectors based on determined codes. Each element of the vectors comprises a component of the determined codes and the matrix itself is used to selectively substantially reduce energy from one or more of the signals.

In one embodiment of the invention, a receiver comprises: a demodulator unit configured for determining a code from each of a plurality of signals and for demodulating one or more of the plurality of signals; and a a processing engine communicatively coupled to the demodulator unit and configured for generating a matrix of one or more vectors based on determined codes, wherein each element of the vectors comprises a component of the determined codes and wherein the matrix is used to selectively substantially reduce energy from one or more of the signals.

In another embodiment of the invention, the receiver further comprises a searcher finger configured for selecting signals for demodulation from said plurality of signals and for determining one or more codes from selected signals.

In another embodiment of the invention, the demodulator unit comprises a plurality of demodulator fingers configured for demodulating the selected signals.

In another embodiment of the invention, the determined codes comprise code offsets in time from one another.

In another embodiment of the invention, the matrix comprises one composite interference vector having one or more elements, wherein each element of the vector includes a component of a determined code and a relative amplitude of one of the signals associated with the determined code.

In another embodiment of the invention, each vector of the matrix has one or more elements, each element comprising a component of a determined code associated with one of the plurality of signals.

In another embodiment of the invention, the receiver further comprises a radio frequency front end configured for receiving the signals.

In another embodiment of the invention, the processing engine comprises a channel selector configured for selecting components of the determined codes from signals selected for energy reduction.

In another embodiment of the invention, the processing engine is further configured to generate a cancellation operator used to substantially reduce the energy of the signals selected for energy reduction.

In another embodiment of the invention, the cancellation operator comprises a projection operator Pₛ^{⊥}having the following form:

Pₛ^{⊥}=I−S(S^{T}S)⁻¹S^{T},

where I is an identity matrix, S is the matrix and S^{T} is a transpose of the matrix.

In another embodiment of the invention, the processing engine comprises an application unit configured for applying the projection operator Pₛ^{⊥}to a desired code x to selectively substantially reduce one or more of the plurality of signals, wherein the projection operator Pₛ^{⊥}is applied to the desired code according to the following form:

Pₛ^{⊥}x=(I−S(S^{T}S)⁻¹S^{T})X.

In another embodiment of the invention, the determined codes are selected from a group consisting of a spreading code and a covering code.

In another embodiment of the invention, the spreading code is a short code.

In another embodiment of the invention, the covering code is selected from a group consisting of a Walsh code and a quasi orthogonal function code.

In another embodiment of the invention, the signals are selected from a group consisting of cdma2000 signals and cdmaOne signals.

In one embodiment of the invention, a method provides for reducing interference to a desired signal and comprises: determining a code from each of a plurality of signals; generating a matrix of one or more vectors based on determined codes, wherein each element of the vectors comprises a component of the determined codes; and using the matrix to selectively substantially reduce energy from one or more of the signals thereby reducing interference.

In another embodiment of the invention, the method further comprises demodulating one or more signals from said plurality of signals.

In another embodiment of the invention, the method further comprises determining one or more codes of signals selected said plurality of signals.

In another embodiment of the invention, generating comprises constructing the matrix from one composite interference vector having one or more elements, wherein each element of the vector includes a component of a determined code and a relative amplitude of one of the signals associated with the determined code.

In another embodiment of the invention, generating comprises constructing the matrix from a plurality of said vectors, wherein each vector of the matrix has one or more elements, each element comprising a component of a determined code associated with one of the plurality of signals.

In another embodiment of the invention, using the matrix comprises generating a cancellation operator for application to a desired code to substantially reduce the energy of the signals selected for energy reduction.

In another embodiment of the invention, generating the cancellation operator comprises generating a projection operator Pₛ^{⊥}having the following form:

Pₛ^{⊥}=I−S(S^{T}S)⁻¹S^{T},

where I is an identity matrix, S is the matrix and S^{T} is a transpose of the matrix.

In another embodiment of the invention, the method further comprises applying the projection operator Pₛ^{⊥}to the desired code to selectively substantially reduce one or more of the plurality of signals, wherein the projection operator Pₛ^{⊥}is applied to the desired code according to the following form:

Pₛ^{⊥}x=(I−S(S^{T}S)⁻¹S^{T})x,

where x is the desired code.

In one embodiment of the invention, a system provides for reducing interference to a desired signal, comprising: means for determining a code from each of a plurality of signals; means for generating a matrix of one or more vectors based on determined codes, wherein each element of the vectors comprises a component of the determined codes; and means for using the matrix to selectively substantially reduce energy from one or more of the signals thereby reducing interference.

In another embodiment of the invention, the system further comprises means for demodulating one or more signals from said plurality of signals.

In another embodiment of the invention, the system further comprises means for determining one or more codes of signals selected from said plurality of signals.

In another embodiment of the invention, the means for generating comprises means for constructing the matrix from one composite interference vector having one or more elements, wherein each element of the vector includes a component of a determined code and a relative amplitude of one of the signals associated with the determined code.

In another embodiment of the invention, the means for generating comprises means for constructing the matrix from a plurality of said vectors, wherein each vector of the matrix has one or more elements, each element comprising a component of a determined code associated with one of the plurality of signals.

In another embodiment of the invention, the means for using the matrix comprises means for generating a cancellation operator for application to a desired code to substantially reduce the energy of the signals selected for energy reduction.

In another embodiment of the invention, the means for generating the cancellation operator comprises means for generating a projection operator Pₛ^{⊥}having the following form:

Pₛ^{⊥}=I−S(S^{T}S)⁻¹S^{T},

where I is an identity matrix, S is the matrix and S^{T} is a transpose of the matrix.

In another embodiment of the invention, the system further comprises means for applying the projection operator Pₛ^{⊥}to the desired code to selectively substantially reduce one or more of the plurality of signals, wherein the projection operator Pₛ^{⊥}is applied to the desired code according to the following form:

Pₛ^{⊥}x=(I−S(S^{T}S)⁻¹S^{T})x,

where x is the desired code.

In one embodiment of the invention, a processing engine comprises: a matrix generator configured for generating a matrix having one or more vectors, wherein the matrix is generated based on a plurality of codes and wherein each element of the vectors comprises a component of the codes; and an application unit communicatively coupled to the matrix generator and configured for using the matrix to selectively substantially cancel one or more of a plurality of signals.

### BRIEF DESCRIPTION OF THE DRAWINGS

FIG. 1 is a block diagram of a processing engine in one exemplary embodiment of the invention.

FIG. 2 is a block diagram of a receiver in one exemplary embodiment of the invention.

FIG. 3 is a block diagram of a receiver in another exemplary embodiment of the invention.

FIG. 4 is a block diagram of a processing engine operable with a demodulation finger in one exemplary embodiment of the invention.

FIG. 5 illustrates matrix generation in one exemplary embodiment of the invention.

FIG. 6 illustrates matrix generation in another exemplary embodiment of the invention.

FIG. 7 illustrates matrix generation in another exemplary embodiment of the invention.

FIG. 8 illustrates matrix generation in another exemplary embodiment of the invention.

FIG. 9 is a flow chart of one exemplary methodical embodiment of the invention.

FIG. 10 is a block diagram of a signal detector used in conjunction with a processing engine in one exemplary embodiment of the invention.

FIG. 11 is a flow chart of one exemplary methodical embodiment of a signal detector used in conjunction with a processing engine in one exemplary embodiment of the invention.

### DETAILED DESCRIPTION OF THE DRAWINGS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

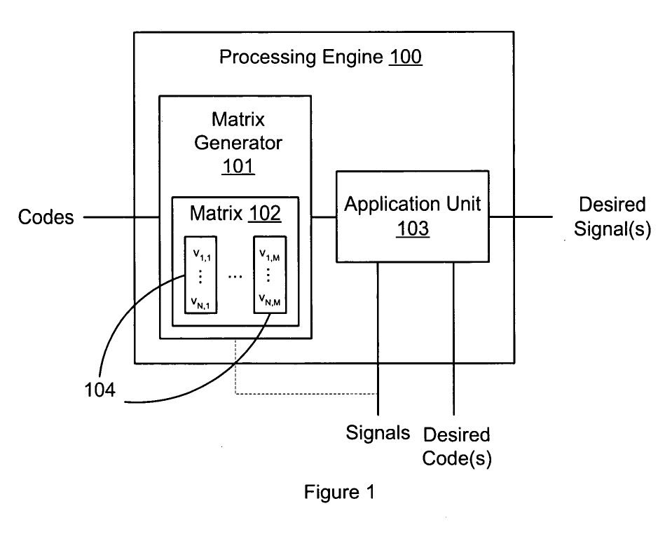

FIG. 1 is a block diagram of processing engine 100 in one exemplary embodiment of the invention. Processing engine 100 is configured for substantially reducing effects of unwanted signals, or interferers, and comprises matrix generator 101 and combiner 103. Matrix generator 101 generates matrix 102 based on a plurality of codes that are input to matrix generator 101. Matrix 102 is generated to comprise one or more vectors 104 with each element v_{1,1} . . . v_{N,1} . . . v_{1,M} . . . v_{N,M} of the vectors comprising a component of the codes, where the subscripts M and N are integers greater than one.

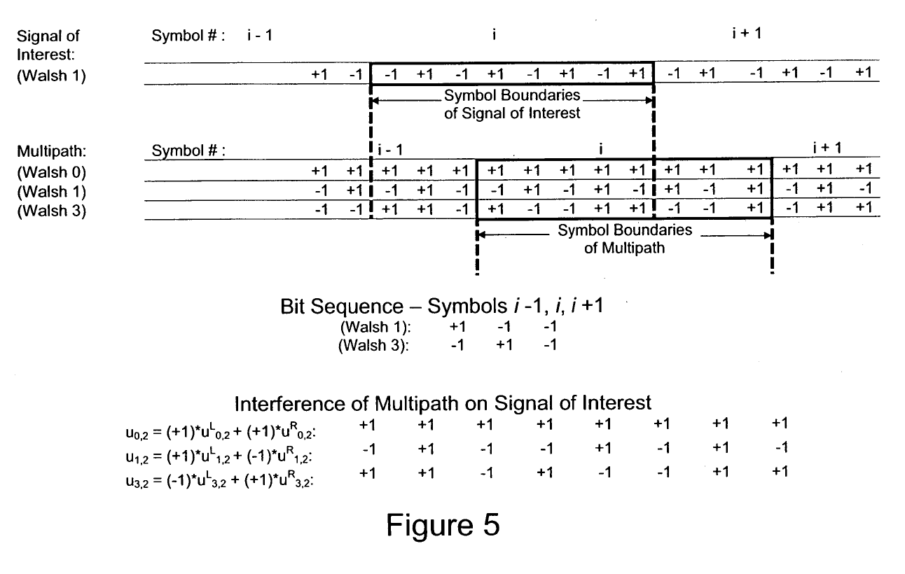

In one embodiment of the invention, matrix generator 101 generates a multi rank cancellation matrix based on Walsh codes and short codes of a plurality of base stations within a CDMA telephony system. Alternatively, matrix generator 101 may generate a single composite vector based on Walsh codes, short codes and/or relative amplitudes of a plurality of base stations and associated channels within such a CDMA telephony system. Construction of matrix 102 is further described in FIGS. 5 through 8.

In either the multi rank cancellation matrix or the single composite vector embodiments, codes of the CDMA signals used in such CDMA telephony systems are known to the receiver. For example, in a typical CDMA telephony system, both Walsh codes and short codes are known at each base station. Each receiver (i.e., each mobile unit) operating within the typical CDMA telephony system has knowledge of the codes used by the system. Accordingly, matrix generator 101 may generate matrix 102 as a multi rank cancellation matrix using code information and possibly bit sequence sign information and/or as a single composite vector using code information and relative amplitude information.

Turning to application unit 103, the application unit is communicatively coupled to matrix generator 101 and configured for using matrix 102 to selectively substantially cancel one or more of a plurality of signals. For example, energy magnitudes of selected interfering signals may be substantially reduced based on the elements v_{1,1} . . . v_{N,1} . . . v_{1M} . . . v_{N,M} of matrix 102 (i.e., based on the code components of the interfering input signals.

In one embodiment of the invention, application unit 103 uses matrix 102 to determine an interference cancellation operator, such as a projection operator. Application unit 103 may then apply the projection operator to one or more desired reference codes to effectuate substantial cancellation of a plurality of received yet unwanted signals. For example, application unit 103 may generate the projection operator Pₛ^{⊥}based on matrix 102. The projection operator Pₛ^{⊥}substantially conforms to the following equation:

Pₛ^{⊥}=I−S(S^{T}S)⁻¹S^{T}, (Eq. 1)

where I is an identity matrix, S is matrix 102 and S^{T} is a transpose of matrix 102. Application unit 103 applies the projection operator Pₛ^{⊥}to a desired code x. The resultant desired code is then combined with a plurality of received signals to substantially selectively reduce one or more of the signals. Accordingly, this application of projection operator Pₛ^{⊥}substantially conforms to the following equation:

Pₛ^{⊥}x=(I−S(S^{T}S)⁻¹S^{T})x. (Eq. 2)

Processing engine 100 may advantageously require use within many of the existing CDMA telephony systems such as cdmaOne and cdma2000. While useful in such CDMA telephony systems, the invention is not intended to be limited to such an implementation. For example, processing engine 100 may be useful in other types of CDMA communication systems, such as GPS communication systems employing CDMA signals. Examples of other CDMA communications may include line communications, such as CDMA data transfers via optical links and wire links (e.g., data buses).

Additionally, the invention is not intended to be limited to the embodiment shown and described herein. Rather, the invention is only intended to be limited by the language recited in the claims below. Accordingly, other embodiments may fall within the scope and spirit of the invention. Such embodiments may be implemented in software, firmware, hardware and/or combinations thereof. For example, one preferred embodiment may implement processing engine 100 within an Application Specific Integrated Circuit (“ASIC”) configurable with other circuitry such as the existing circuitry of a CDMA cellular telephone.

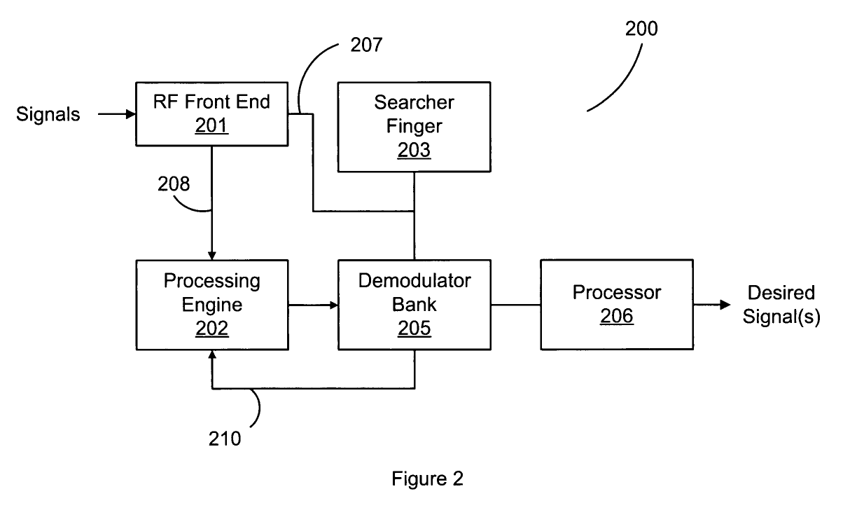

FIG. 2 is a block diagram of receiver 200 in one exemplary embodiment of the invention. Receiver 200 may be a CDMA receiver such as that used in a mobile CDMA telephony unit. Receiver 200 is typically configured having RF front end 201, searcher finger 203, demodulator bank 205 and processor 206 (see e.g., the '587 patent). A noted distinction between receiver 200 of the present embodiment and that of the prior art is the addition of processing engine 202.

Processing engine 202 is similar in design and operation to processing engine 100 of FIG. 1. Processing engine 202 may substantially reduce interference caused by unwanted signals by mathematically canceling the energy of the signals. The signals may be selectively substantially cancelled based on codes used in a CDMA telephony system. Demodulator bank 205 transfers determined code information derived from the received signal to processing engine 202 via link 210 wherein processing engine 202 subsequently generates a matrix based on the determined codes as described in FIG. 1. Each element of the one or more vectors forming the matrix comprises a component of the determined codes. Processing engine 202 may then use the matrix to generate a projection operator for application to the desired reference signals. The projection operator may substantially reduce energy of unwanted signals, or interferers.

Typical receiver configurations employ an RF front end such as that of RF front end 201 to receive the RF signals and down convert those signals to a baseband frequency range for the purpose of demodulation. As such RF signals are analog in nature, the RF front end typically comprises circuitry that converts the analog signals into a digital format. Such an “A/D” conversion is well known to those skilled in the art.

The RF front end 201 transfers the digital baseband signal via link 207 to searcher finger 203 and a demodulator bank 205 for acquisition and tracking purposes. For example, searcher FIG. 203 maybe used to identify signals of interest within the received and digital baseband signals. Searcher finger 203 may then assign signals of interest to demodulation elements of the demodulator bank 205. Such demodulation elements may include demodulation fingers as known to those skilled in the art. Demodulator bank 205 is subsequently tasked by control circuitry within processor 206 to track and demodulate assigned signals of interest.

Once demodulator bank 205 synchronizes with the signals, demodulator bank 205 locks on to the signals using time tracking and phase estimation, thereby maintaining tracking of the signals. Once the signals are acquired, demodulator bank 205 can demodulate the signals for subsequent processing by a processor 206.

In this embodiment, however, RF front end 201 and demodulator bank 205 also communicatively link to processing engine 202 via links 208 and 210, respectively. RF front end 201 may provide the baseband signals to processing engine 202 such that processing engine 202 can apply the above mentioned orthogonal projection operator to the reference signals. Such an application of the orthogonal projection operator may substantially reduce energy magnitudes of unwanted signals thereby improving subsequent demodulation of the signals of interest via demodulator bank 205 and subsequent processing of signals of interest via processor 206.

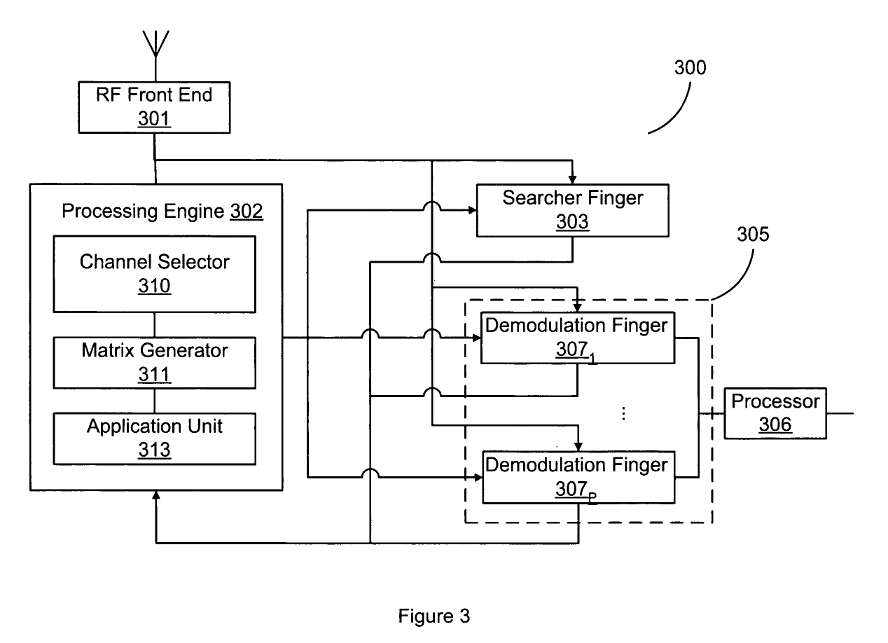

FIG. 3 is a block diagram of a receiver 300 in another exemplary embodiment of the invention. Such a receiver may be used in a mobile unit of a CDMA telephony system. For example, base stations (not shown but described above) transmit encoded signals, or channels. Receiver 300 receives such channels via RF front end 301. Processing engine 302 may selectively substantially reduce energy magnitudes of unwanted signals received by receiver 300.

To illustrate, the forward link of a cdma2000 cellular telephony system includes an RF carrier modulated by a baseband signal spread with a short code and covered by a Walsh covering code or a QOF covering code. Each base station is distinguished by a short code offset with a chip separation that is sufficient to differentiate between signals of other base stations. The mobile station is assigned a unique Walsh or QOF covering code by the base station that is orthogonal or substantially orthogonal to all other Walsh codes assigned to other mobile stations by that base station. As such, each code of a QOF family has a near zero cross-correlation with codes of other QOF families.

In the cdma2000 example, channels that are assigned by a particular base station may consist of shorter length Walsh codes derived from smaller Hadamard matrices. Those skilled in the art should readily understand Hadamard matrices and associated Walsh code derivations. In addition to typical fundamental traffic channels, the base station may assign supplemental channels to mobile units for use as high data rate traffic channels. The base station also transmits common channels, such as the pilot, paging and synchronization channels. Typically, the pilot channel is used for identification of a particular CDMA telephony system, system power estimation, signal acquisition and tracking and coherent demodulation of other channels. The paging channel is typically used to send paging information, such as call initialization information, to a mobile unit, whereas the synchronization channel is typically used for timing synchronization between the base station and the mobile unit.

Receiver 300 consists of an RF front end 301 configured for receiving these signals and down converting the signals to baseband and additionally converting such analog signals to a digital format. For example, RF front end 301 may down sample a received QPSK CDMA signal and decompose the signal into a complex baseband signal with I and Q components. Those skilled in the art should readily recognize that, while single connections are shown, processing may be performed on both the I and Q channels.

Searcher finger 303 may correlate baseband data from RF front end 301 with a PN reference code (i.e., short code) in order to determine the code offset assigned to a particular base station. Searcher finger 303 or other control device assigns demodulation fingers 301₁ . . . 307_{P} (where the subscript P is an integer greater than one) to track a signal of interest (e.g., each demodulation finger may be assigned a unique finger of a multipath signal). Processing engine 302 may remove interfering signals by projecting a reference signal onto a subspace orthogonal to such interference. For example, processing engine 302 may generate an orthogonal projection operator for application to one or more desired reference codes as described in FIG. 1. When such projected codes are subsequently correlated against received signals, unwanted signals are substantially removed from desired signals.

In this exemplary embodiment, processing engine 302 comprises three sub components: channel selector 310, matrix generator 311 and application unit 313. Channel selector 310 may be configured for ranking and/or selecting interference caused by each finger to be suppressed. Matrix generator 311 may generate a multi-rank interference matrix, a composite interference vector (CIV) or a combination thereof. Such matrix generation has been briefly described herein above and is further described throughout FIGS. 5 through 8. Processing engine 302 may further calculate the orthogonal projection operator based on the matrix for application to the desired code(s) and selected reduction of interfering signals within the received signals.

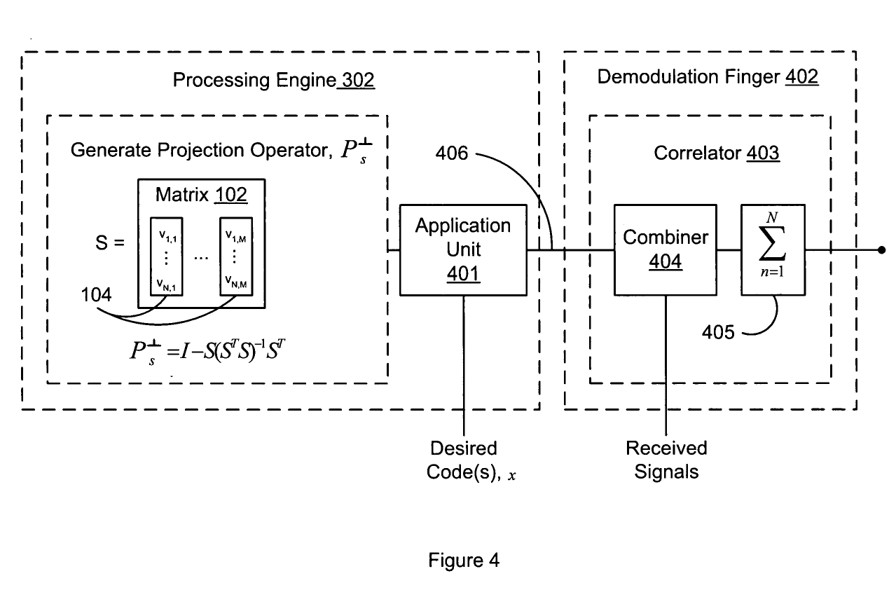

FIG. 4 is a block diagram of processing engine 302 of FIG. 3 operable with one of the demodulation fingers 307 of FIG. 3 in one exemplary embodiment of the invention. In this embodiment, processing engine 302 generates an orthogonal projection operator Pₛ^{⊥}as shown in Eq. 1 based on matrix 102 of FIG. 1. Processing engine 302 includes application unit 401 which applies the orthogonal projection operator Pₛ^{⊥}to a reference signal, such as a desired code. Application of the orthogonal projection operator Pₛ^{⊥}to the references signal may thereby create an interference cancelled reference signal 406 by projecting the reference signal onto a subspace orthogonal to interfering signals. The interference cancelled reference signal 406 is transferred to correlator 403 of demodulator finger 402.

Correlator 403 comprises combiner 404 configured for combining the interference cancelled reference signal 406 with received signals. Such a combination process may substantially suppress any unwanted signals and remove the desired signal's short code. This essentially interference-free signal may then be transferred to summation unit 405 for demodulation of the signal. For example, summation unit 405 may sum the signal over a symbol length N chips which subsequently demodulate the signal. Those skilled in the art should readily recognize such digital demodulation techniques.

Those skilled in the art should readily recognize that the above embodiment is exemplary in nature. Accordingly, the embodiment is not intended to be limited that which is shown and described herein. Other embodiments may also fall within the scope and spirit of the invention.

FIG. 5 illustrates matrix generation in one exemplary embodiment of the invention. More specifically, FIG. 5 illustrates the generation of a multi rank cancellation matrix by a matrix generator, such as matrix generator 101 of FIG. 1. Such a multi rank cancellation matrix may be used by a processing engine (e.g., processing engine 302 of FIGS. 3 and 4) to produce a projection operator, such as that of Eq. 1. The projection operator may be applied to a reference signal to substantially reduce energy magnitudes of interfering signals when combined with the received baseband signal.

In this exemplary embodiment, indices i−1, i and i+1 represent symbols of a signal of interest coinciding with interfering signals of three Walsh codes. As shown in this embodiment, the Walsh codes are derived from a rank 8 Hadamard matrix. A pilot channel is illustrated as using the Walsh code Walsh 0 wherein the bit sequence are all +1's. Other channels are illustrated as using Walsh 1 having a bit sequence of +1, −1, −1 and using Walsh 3 having a bit sequence of −1, +1 and −1. Those skilled in the art should readily recognize that Walsh codes may be derived from other rank Hadamard matrices. For example, Walsh codes may be derived from rank 64 or rank 128 Hadamard matrices. Accordingly, the invention is not intended to be limited to the exemplary embodiment of a rank 8 Hadamard matrix.

As shown in this exemplary embodiment, a 3-chip delay exists between the signal of interest and interfering signals. A symbol boundary of the interfering signals lies within each symbol of the signal of interest. As each symbol is independently modulated, it may be desirable to determine the sign of each symbol and form an interference vector for each channel with respect to the symbol of interest.

Accordingly, u^{L}_{i,j} is denoted as interference from Walsh code i, multipath j overlapping a left side portion of the symbol of interest. Walsh codes are typically numbered from 0-63 or 0-127 depending on whether cdmaOne or cdma2000 is used. The index i is an index that specifies which row (or column) of the Hadamard matrix is used as the particular Walsh code. The use of the index j refers to the order in which copies (i.e., multipath) of the signal arrive. For example, the LOS may be numbered ‘1’, the first multipath ‘2’, et cetera. Similarly, u^{R}_{i,j} is denoted as the interference from Walsh code i, multipath j overlapping a right side portion of the symbol of interest. Components of the interference vectors overlapping the left side of the symbol of interest are therefore given by:

$$\begin{matrix}{u}_{0 , 2}^{L} = \{ + 1 , + 1 , + 1 , 0 , 0 , 0 , 0 , 0 \} \\ {u}_{1 , 2}^{L} = \{ - 1 , + 1 , - 1 , 0 , 0 , 0 , 0 , 0 \} \\ {u}_{3 , 2}^{L} = \{ - 1 , - 1 , + 1 , 0 , 0 , 0 , 0 , 0 \} .\end{matrix}$$

Chips beyond the symbol boundary of the left side component of the interference vector are set to 0. Similarly, the components of the interference vectors overlapping the right side of the symbol of interest are given by:

$$\begin{matrix}{u}_{0 , 2}^{R} = \{ 0 , 0 , 0 , + 1 , + 1 , + 1 , + 1 , + 1 \} \\ {u}_{1 , 2}^{R} = \{ 0 , 0 , 0 , + 1 , - 1 , + 1 , - 1 , + 1 \} \\ {u}_{3 , 2}^{R} = \{ 0 , 0 , 0 , + 1 , - 1 , - 1 , + 1 , + 1 \} .\end{matrix}$$

Independent symbol modulation may be taken into account to suppress the interference. Based on the bit sequence of the desired signal, independent multiplication of the chips corresponding to each respective symbol may be performed. The chips of the left side and right side portions of the interference signal may then be multiplied by the bit sequence to form the interference vectors:

$$\begin{matrix}{u}_{0 , 2} = {( + 1 )}^{*} {u}_{0 , 2}^{L} + {( + 1 )}^{*} {u}_{0 , 2}^{R} = \{ + 1 , + 1 , + 1 , + 1 , + 1 , + 1 , + 1 , + 1 \} \\ {u}_{1 , 2} = {( + 1 )}^{*} {u}_{1 , 2}^{L} + {( - 1 )}^{*} {u}_{1 , 2}^{R} = \{ - 1 , + 1 , - 1 , - 1 , + 1 , - 1 , + 1 , - 1 \} \\ {u}_{3 , 2} = {( - 1 )}^{*} {u}_{3 , 2}^{L} + {( + 1 )}^{*} {u}_{3 , 2}^{R} = \{ + 1 , + 1 , - 1 , + 1 , - 1 , - 1 , + 1 , + 1 \} .\end{matrix}$$

As illustrated, the left and right halves of a u vector contain interfering codes without information as to what bit was transmitted. A u vector may be defined as a combination of the left and the right halves appropriately multiplied by corresponding bits (i.e., sign information). The resultant interference vectors u_{0,2}, u_{1,2} and u_{3,2} may be used as vectors in the construction of an interference matrix S. Such an interference matrix S may then be used by a processing engine, such as processing engine 302 of FIGS. 3 and 4, to generate the projection operator described above herein. As shown in this embodiment, the interference matrix is formed independent of any amplitude information for the signals. Accordingly, a projection operator generated from such a matrix S may substantially reduce energy magnitudes of unwanted signals without a priori knowledge of signal strengths.

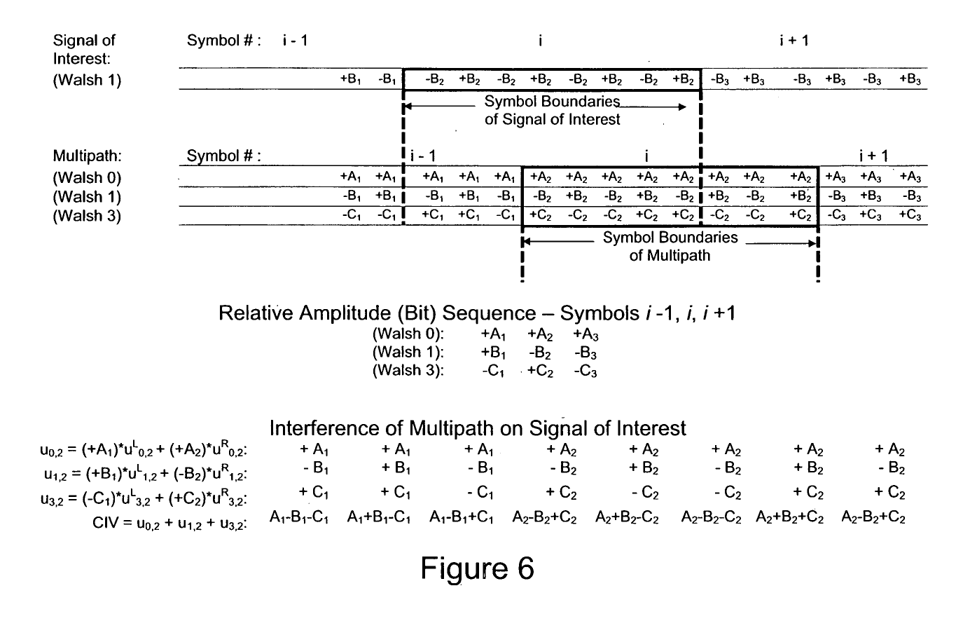

FIG. 6 illustrates matrix generation in another exemplary embodiment of the invention. More specifically, FIG. 6 illustrates the generation of a composite interference vector by a matrix generator, such as matrix generator 101 of FIG. 1. Such a composite interference vector may be used by a processing engine (e.g., processing engine 302 of FIGS. 3 and 4) to produce a projection operator, such as that of Eq 1. As in FIG. 5, the projection operator may be applied to a reference signal to substantially reduce energy magnitudes of interfering signals.

In this exemplary embodiment, indices i−1, i and i+1 represent symbols of a signal of interest coinciding with interfering signals of three Walsh codes. As shown in this embodiment, the Walsh codes are again derived from a Rank 8 Hadamard matrix. However, the Walsh codes of this embodiment are illustrated as having associated relative amplitude represented by letters A, B and C. Other Walsh code characteristics (e.g., signed bit sequence) described in this exemplary embodiment are consistent with those of FIG. 5.

From FIG. 5, the components of the interference vectors overlapping the left side of the symbol of interest are given by:

$$\begin{matrix}{u}_{0 , 2}^{L} = \{ + 1 , + 1 , + 1 , 0 , 0 , 0 , 0 , 0 \} \\ {u}_{1 , 2}^{L} = \{ - 1 , + 1 , - 1 , 0 , 0 , 0 , 0 , 0 \} \\ {u}_{3 , 2}^{L} = \{ - 1 , - 1 , + 1 , 0 , 0 , 0 , 0 , 0 \} .\end{matrix}$$

The chips beyond the symbol boundary of the left side component of the interference vector are set to 0. Similarly, the components of the interference vectors overlapping the right side of the symbol of interest are given by:

$$\begin{matrix}{u}_{0 , 2}^{R} = \{ 0 , 0 , 0 , + 1 , + 1 , + 1 , + 1 , + 1 \} \\ {u}_{1 , 2}^{R} = \{ 0 , 0 , 0 , + 1 , - 1 , + 1 , - 1 , + 1 \} \\ {u}_{3 , 2}^{R} = \{ 0 , 0 , 0 , + 1 , - 1 , - 1 , + 1 , + 1 \} .\end{matrix}$$

The chips of the left side and right side portions of the interference signal may then be multiplied by the bit sequence to form the amplitude-inclusive interference vectors:

$$\begin{matrix}{u}_{0 , 2} = {( + {A}_{1} )}^{*} {u}_{0 , 2}^{L} + {( + {A}_{2} )}^{*} {u}_{0 , 2}^{R} \\ = \{ + {A}_{1} , + {A}_{1} , + {A}_{1} , + {A}_{2} , + {A}_{2} , + {A}_{2} , + {A}_{2} , + {A}_{2} \} \\ {u}_{1 , 2} = {( + {B}_{1} )}^{*} {u}_{1 , 2}^{L} + {( - {B}_{2} )}^{*} {u}_{1 , 2}^{R} \\ = \{ - {B}_{1} , + {B}_{1} , - {B}_{1} , - {B}_{2} , + {B}_{2} , - {B}_{2} , + {B}_{2} , - {B}_{2} \} \\ {u}_{3 , 2} = {( - {C}_{1} )}^{*} {u}_{3 , 2}^{L} + {( + {C}_{2} )}^{*} {u}_{3 , 2}^{R} \\ = \{ + {C}_{1} , + {C}_{1} , - {C}_{1} , + {C}_{2} , - {C}_{2} , - {C}_{2} , + {C}_{2} , + {C}_{2} \} .\end{matrix}$$

The composite interference vector CIV may then be generated by the matrix generator by summing the relative amplitude-scaled vectors as follows:

$$CIV = {u}_{0 , 2} + {u}_{1 , 2} + {u}_{3 , 2}$$

$$CIV = \{ {A}_{1} - {B}_{1} - {C}_{1} , {A}_{1} + {B}_{1} - {C}_{1} , {A}_{1} - {B}_{1} + {C}_{1} , {A}_{2} - {B}_{2} + {C}_{2} , {A}_{2} + {B}_{2} - {C}_{2} , {A}_{2} - {B}_{2} - {C}_{2} , {A}_{2} + {B}_{2} + {C}_{2} , {A}_{2} - {B}_{2} + {C}_{2} \} .$$

The resultant composite interference vector CIV may be used in the construction of the interference matrix S and used by the processing engine to generate the orthogonal projection operator described above herein. The construction of the CIV produces an S matrix with fewer elements. Accordingly, an orthogonal projection operator generated from such a matrix S may substantially reduce energy magnitudes of unwanted signals with fewer calculations.

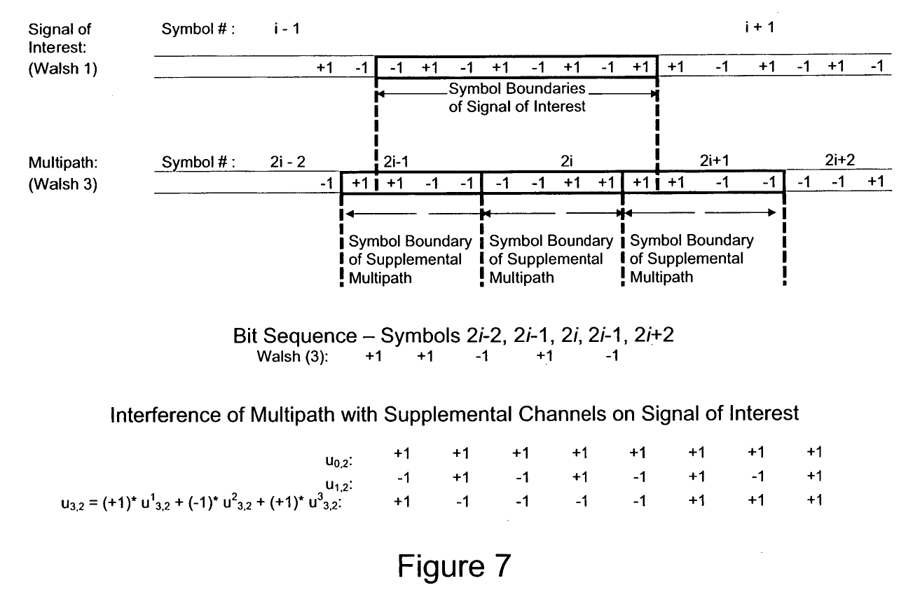

FIG. 7 illustrates matrix generation in another exemplary embodiment of the invention. More specifically, FIG. 7 illustrates the generation of a multi rank cancellation matrix by a matrix generator, such as matrix generator 101 of FIG. 1. In this exemplary embodiment, the matrix is generated for a system employing supplemental channels that use “short” Walsh codes.

As shown in this exemplary embodiment, indices i−1, i and i+1 represent symbols of a signal of interest coinciding with interfering signals of three Walsh codes. With the short Walsh code of this embodiment, the symbol rate is double that shown in FIGS. 5 and 6. Correspondingly, there exist twice as many symbols for a given duration of time. The Walsh codes of this exemplary embodiment are derived from a Rank 8 Hadamard matrix for all codes but Walsh 3. The Walsh 3 code is a supplemental channel Walsh code derived from a Rank 4 Hadamard matrix. Accordingly, the bit sequence for the Walsh 3 is +1, +1, −1, +1, −1.

As shown in this exemplary embodiment, a 3-chip delay exists between the signal of interest and interfering signals. A symbol boundary of the interfering signals lies within each symbol of the signal of interest. Because of the higher symbol rate, more than one symbol boundary of the interfering signals lie within each symbol of the signal of interest.

In this exemplary embodiment, uⁿ_{i,j} denotes interference from the n^{th} overlapping symbol, Walsh code i, multipath j, which overlaps a portion of the symbol of interest. For example, the nth overlapping symbol may denote a particular symbol from an ordered sequence of interfering symbols that overlaps the symbol of interest. Accordingly, the overlapping terms may be numbered sequentially. The components of the interference vectors overlapping the symbol of interest from the left to right may be given by:

$$\begin{matrix}{u}_{3 , 2}^{1} = \{ + 1 , - 1 , - 1 , 0 , 0 , 0 , 0 , 0 \} \\ {u}_{3 , 2}^{2} = \{ 0 , 0 , 0 , + 1 , + 1 , - 1 , - 1 , 0 \} \\ {u}_{3 , 2}^{3} = \{ 0 , 0 , 0 , 0 , 0 , 0 , 0 , + 1 \} .\end{matrix}$$

The chips of the overlapping portions of the interference may then be multiplied by the bit sequence to form the interference vectors:

$$\begin{matrix}{u}_{0 , 2} = {( + 1 )}^{*} {u}_{0 , 2}^{L} + {( + 1 )}^{*} {u}_{0 , 2}^{R} = \{ + 1 , + 1 , + 1 , + 1 , + 1 , + 1 , + 1 , + 1 \} \\ {u}_{1 , 2} = {( + 1 )}^{*} {u}_{1 , 2}^{L} + {( - 1 )}^{*} {u}_{1 , 2}^{R} = \{ - 1 , + 1 , - 1 , - 1 , + 1 , - 1 , + 1 , - 1 \} \\ {u}_{3 , 2} = {( + 1 )}^{*} {u}_{3 , 2}^{1} + {( - 1 )}^{*} {u}_{3 , 2}^{2} + {( + 1 )}^{*} {u}_{3 , 2}^{3} \\ = \{ + 1 , - 1 , - 1 , - 1 , - 1 , + 1 , + 1 , + 1 \} .\end{matrix}$$

The resulting interference vectors u_{0,2}, u_{1,2} and u_{3,2} may be used as vectors in the construction of the interference matrix S, again without estimation of amplitude information.

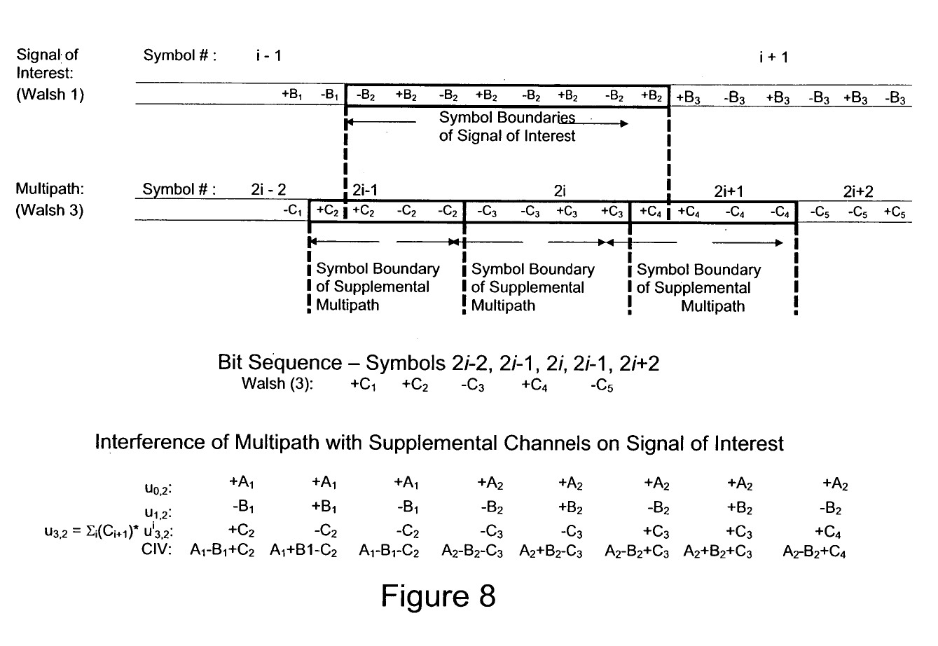

FIG. 8 illustrates matrix generation in another exemplary embodiment of the invention. More specifically, FIG. 8 illustrates the generation of a composite interference vector by a matrix generator, such as matrix generator 101 of FIG. 1. In this exemplary embodiment, the composite interference vector is generated for a system employing supplemental channels that use “short” Walsh codes.

In this exemplary embodiment, uⁿ_{i,j} denotes interference from Walsh code i, multipath j, which overlaps the n^{th} portion of the symbol of interest. The components of the interference vectors overlapping the symbol of interest from the left to right are given by:

$$\begin{matrix}{u}_{3 , 2}^{1} = \{ + 1 , - 1 , - 1 , 0 , 0 , 0 , 0 , 0 \} \\ {u}_{3 , 2}^{2} = \{ 0 , 0 , 0 , + 1 , + 1 , - 1 , - 1 , 0 \} \\ {u}_{3 , 2}^{3} = \{ 0 , 0 , 0 , 0 , 0 , 0 , 0 , + 1 \} .\end{matrix}$$

The chips of the right and left halves of the interference are multiplied appropriately by the sequence of relative amplitudes to form the interference vectors:

$$\begin{matrix}{u}_{0 , 2} = ( + {A}_{1} ) * {u}_{0 , 2}^{L} + ( + {A}_{2} ) * {u}_{0 , 2}^{R} \\ = \{ + {A}_{1} , + {A}_{1} , + {A}_{1} , + {A}_{2} , + {A}_{2} , + {A}_{2} , + {A}_{2} , + {A}_{2} \} \\ {u}_{1 , 2} = ( + {B}_{1} ) * {u}_{1 , 2}^{L} + ( - {B}_{2} ) * {u}_{1 , 2}^{R} \\ = \{ - {B}_{1} , + {B}_{1} , - {B}_{1} , - {B}_{2} , + {B}_{2} , - {B}_{2} , + {B}_{2} , - {B}_{2} \} \\ {u}_{3 , 2} = ( + {C}_{2} ) * {u}_{3 , 2}^{1} + ( - {C}_{3} ) * {u}_{3 , 2}^{2} + ( + {C}_{4} ) * {u}_{3 , 2}^{3} \\ = \{ + {C}_{2} , - {C}_{2} , - {C}_{2} , - {C}_{3} , - {C}_{3} , + {C}_{3} , + {C}_{3} , + {C}_{4} \} .\end{matrix}$$

The relative amplitude scaled vectors may be summed to form the composite interference vector CIV as follows:

$$\begin{matrix}CIV = {u}_{0 , 2} + {u}_{1 , 2} + {u}_{3 , 2} ; \\ CIV = \{ {A}_{1} - {B}_{1} + {C}_{2} , {A}_{1} + {B}_{1} - {C}_{2} , {A}_{1} - {B}_{1} - {C}_{2} , \\ {A}_{2} - {B}_{2} - {C}_{3} , {A}_{2} + {B}_{2} - {C}_{3} , {A}_{2} - {B}_{2} + {C}_{3} , \\ {A}_{2} + {B}_{2} + {C}_{3} , {A}_{2} - {B}_{2} + {C}_{4} \} .\end{matrix}$$

The resultant composite interference vector CIV may be used in the construction of the interference matrix S and used by a processing engine, such as processing engine 302 of FIGS. 3 and 4, to generate the orthogonal projection operator.

The exemplary embodiments of FIGS. 5-8 are provided for illustrative purposes. Such matrix generation may apply to arbitrary length covering codes, arbitrary length chip offsets and/or instances involving an arbitrary number of short code offsets.

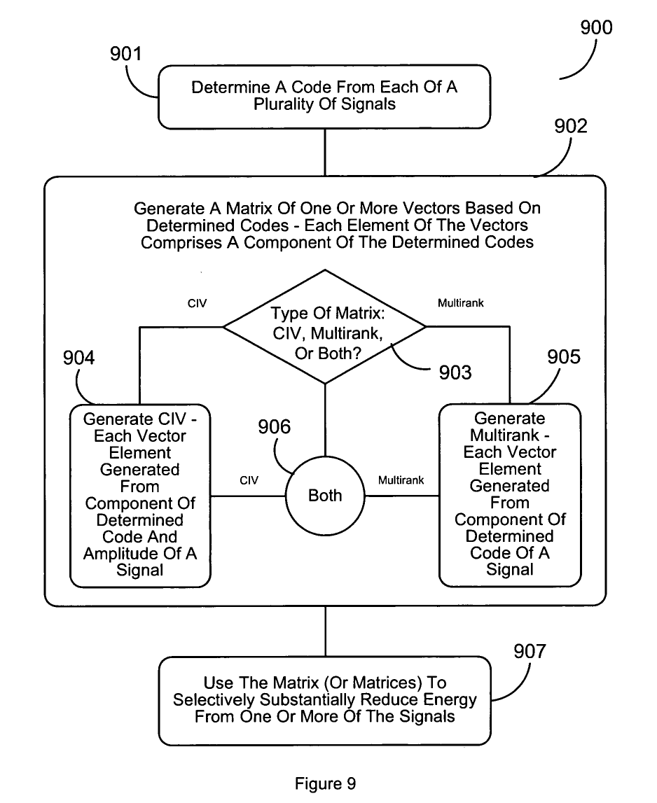

FIG. 9 is a flow chart 900 of one exemplary methodical embodiment of the invention. In this embodiment, a method provides for the generation of a matrix used to selectively substantially cancel interfering signals within a received plurality of signals. A code is determined from each of a plurality of signals, in element 901. Each code may be a particular Walsh or QOF covering code used in a CDMA telephony system.

A matrix is generated based on determined codes, in element 902. The matrix can have one or more vectors with each element of the vectors comprising a component of the determined codes. The type of matrix to be generated may be determined, in element 903. For example, the matrix may include a composite interference vector or a multi-rank matrix. The composite interference vector generated, in element 904 may include vector elements each comprising a component of a determined code of one signal as well as an amplitude component of that signal. The multi-rank matrix generated, in element 905 comprises a plurality of vectors with the elements of each vector comprising components of a determined code for one signal. In one embodiment, both of such matrices may be generated, in element 906. Such an embodiment is a matter of design choice. Once the matrix (or matrices) is generated, the matrix may be used to selectively substantially reduce energy magnitudes from one or more of the interfering signals, in element 907. For example, the matrix may be used to generate a projection operator, such as that described herein above. Since the matrix comprises vector information regarding selected interfering signals, an orthogonal projection operator generated from such a matrix may substantially remove the signal from the reference signal, thereby improving demodulation of the desired signal for processing. In an embodiment wherein both the CIV and the multi rank matrices are produced, a plurality of projection operators may be generated.

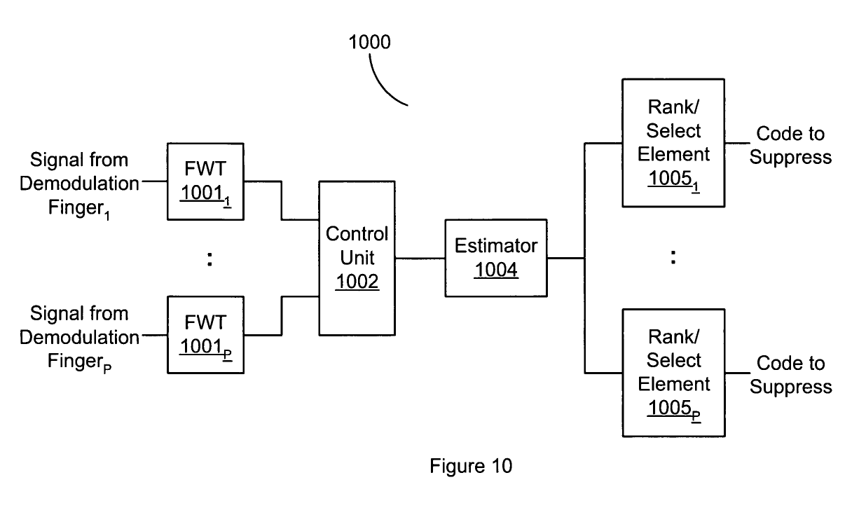

FIG. 10 is a block diagram of signal detector 1000 used in conjunction with a processing engine, such as processing engine 302 of FIGS. 3 and 4, in one exemplary embodiment of the invention. Such an embodiment may advantageously require use in a CDMA telephony receiver (e.g. a mobile unit). Signal detector 1000 is configured for ranking and/or selecting interfering signals based on signal characteristics such as signal strength. Signal detector 1000 may determine which interference vectors are to be included (e.g., signals to be cancelled) in a matrix used to substantially cancel unwanted signals, such as matrix 102 of FIG. 1.

Detector 1000, in this exemplary embodiment, includes a plurality of Fast Walsh Transform (“FWT”) operators 1001, each configured for performing an FWT upon a signal from a demodulation finger, such as demodulation finger 307 of FIG. 3. FWT operators 1001 may indicate present channels in a received CDMA signal by correlating a despread received signal against a plurality of Walsh code symbols of varying length that were possibly transmitted by a base station.

To determine present channels, FWT operators 1001 may perform operations of active channel determination by comparing channel amplitudes against a threshold amplitude. Such a threshold amplitude may be based in part on an averaged amplitude of a synchronization channel for a particular base station that is in communication with the CDMA telephony receiver. As such, FWT operators 1001 may then use channels that exceed the threshold amplitude to construct a matrix for use in interference cancellation of the Walsh code symbols estimated to have been transmitted. Each of FWT operators 1001 may initially search for shorter Walsh codes (e.g., supplemental channels) and subsequently search for longer Walsh codes in the same family once an FWT operator determines that the shorter Walsh codes are not present within a particular signal.

Signal detector 1000 also includes control unit 1002 communicatively coupled to the FWT operators 1001 and configured for selecting outputs from the FWT operators 1001. Control unit 1002 may combine certain outputs based on a desired operation to be performed. A rake receiver may assign certain demodulation finger to measure interference parameters. Other demodulation fingers may be assigned to determine soft hand off operations between base stations and a mobile unit. Indications of present channels are provided to estimator 1004. Estimator 1004 may estimate which channels are present on a demodulation finger basis so that present channels may be ranked by rank/select elements 1005. Rank/select elements 1005 are configured for ranking and/or selecting channels according to a predetermined criteria, such as signal strength, PN code and/or Walsh code. Rank/select elements 1005 may then select to be included in the matrix according to rank. For example, some channels may not need to be included in the matrix as their interfering characteristics do not meet threshold levels. Accordingly, the matrix may include fewer channels thereby decreasing the complexity of calculations.

Rank/select elements 1005 may produce a plurality of codes to suppress. The codes to suppress form ranked interference vectors of the matrix. The codes to suppress may then be provided to the processing engine for matrix generation and subsequent projection operator generation. Such generations are described in the embodiments above herein.

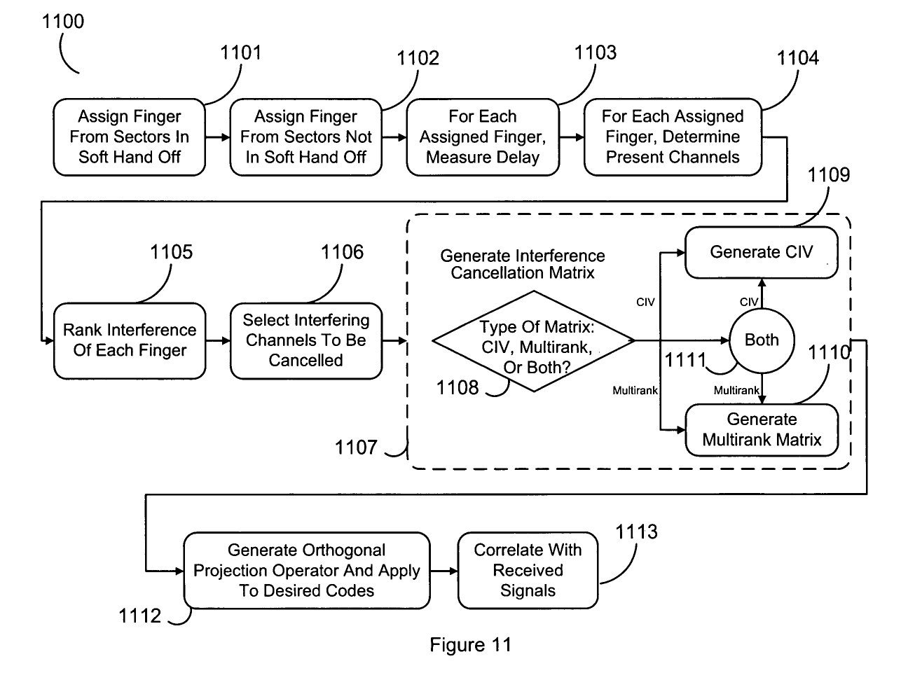

FIG. 11 is a flow chart of one methodical embodiment of a signal detector, such as signal detector 1000 of FIG. 10, used in conjunction with a processing engine, such as processing engine 302 of FIGS. 3 and 4, in one exemplary embodiment of the invention. In this exemplary embodiment, demodulation fingers are assigned according to base stations in soft handoff with the mobile unit should any such base station signals exist, in element 1101. Additionally, demodulation fingers are assigned to signals from base stations not in soft handoff, in element 1102. Preferably, available demodulation fingers are assigned to either a multipath signal from base station in soft handoff with the mobile unit or to a strong multipath signal from base stations not in soft handoff. As such, all available demodulation fingers may be assigned. The assigned demodulation fingers may, therefore, be used to combine multipath signals from soft handoffs and/or to identify interference from base stations not in soft handoff.

A delay is measured for each assigned demodulation finger, in element 1103. From these measured delays, a determination of which channels are present at each assigned demodulation finger is made, in element 1104. In one embodiment, a Fast Walsh Transform (FWT) may be used to accomplish such a determination.

Interference caused by channels (i.e., caused by channels unwanted signals) may be ranked for each demodulation finger, in element 1105. Ranking of interference may be performed in accordance with the ranking described in FIG. 10. For example, a list of interfering channels is prepared with interfering channels ranked by amplitude and/or other ranking/selection criteria. A list of interfering signals may be prepared for each demodulation finger by ranking individual interfering signals received by each demodulation finger. Alternative embodiments may not require ranking element 1105.

Interfering signals to be suppressed may be selected using either ranked or unranked lists of interfering signals, in element 1106. Selection of these signals for matrix generation, as described herein above, may be made using any suitable criteria. For example, a set of interference vectors (i.e., formed from components of the interfering signals) that exceeds a particular threshold amplitude, such as an averaged amplitude of a synchronization channel, may be included in the construction of the matrix. These interference vectors form the matrix used to suppress interfering signals.

The matrix is generated in element 1107. A determination is made as to which type of matrix should be generated, a CIV (element 1109), a multi rank matrix (element 1110) or both (element 1111), in element 1108. Such a determination may be a matter of design choice or even input by a user or original equipment manufacturer. For example, should computational and/or other constraints not preclude generation of both, a mobile unit may be pre-programmed to generate both matrices, in element 1111. Such matrix generation may be consistent with such matrix generations described herein above.

Once the matrix is generated, a projection operator is generated from the matrix, in element 1112. The projection operator will project a vector onto a subspace substantially orthogonal to the selected interfering signals. Once the orthogonal projection operator is generated and applied to the desired reference signal, the received data is correlated (i.e., despread) using the projection operator as applied to the reference signal, in element 1113. By using the projection operator (e.g., as applied to the reference signal), each of the interfering signals is substantially removed from the desired signal(s).

Those skilled in the art should readily recognize that the order of the illustrated elements may be performed in a variety of manners. For example, elements 1101 and 1102 may be performed either simultaneously or in a manner opposite to that described above. Accordingly, the invention is not intended to be limited to the particular embodiment shown; rather, the invention is only intended to be limited by the language recited in the claims.

The embodiments described herein may substantially reduce interference caused by unwanted signals and improve signal processing. For example, poor signal quality due to interference may deleteriously affect acquisition, tracking and demodulation of desired signals. A reduction in interference may therefore result in improved signal processing and error reduction. In regards to such benefits, the embodiments herein may advantageously require use within a CDMA telephony system. Improved processing within a CDMA telephony system may be exploited in terms of increased system capacity, system coverage and/or data rate.

It should be noted that the above embodiments of the invention may be implemented in a variety of ways. For example, the above embodiments may be implemented from software, firmware, hardware or any combination thereof. Those skilled in the art are familiar with software, firmware, hardware and their various combinations. Accordingly, those skilled in the art should readily recognize that such implementations are a matter of design choice and should not be limited to any particular implementation.

While the invention has been illustrated and described in detail in the drawings and foregoing description, such illustration and description is to be considered as exemplary and not restrictive in character. Accordingly, it should be understood that only the preferred embodiment and minor variants thereof have been shown and described and that all changes and modifications that come within the spirit of the invention are desired to be protected.

What is claimed is:

1. A receiver, comprising:
a demodulator unit configured for determining a code from each of a plurality of signals and for demodulating one or more of the plurality of signals; and
a processing engine communicatively coupled to the demodulator unit and configured for generating a matrix of one or more vectors based on determined codes, wherein each element of the vectors comprises a component of the determined codes and wherein the matrix is used to selectively substantially reduce energy from one or more of the signals.

2. The receiver of claim 1, further comprising a searcher finger configured for selecting signals for demodulation from said plurality of signals and for determining one or more codes from selected signals.

3. The receiver of claim 2, wherein the demodulator unit comprises a plurality of demodulator fingers configured for demodulating the selected signals.

4. The receiver of claim 2, wherein the determined codes comprise code offsets in time from one another.

5. The receiver of claim 1, wherein the matrix comprises one composite interference vector having one or more elements, wherein each element of the vector includes a component of a determined code and a relative amplitude of one of the signals associated with the determined code.

6. The receiver of claim 1, wherein each vector of the matrix has one or more elements, each element comprising a component of a determined code associated with one of the plurality of signals.

7. The receiver of claim 1, wherein the receiver further comprises a radio frequency front end configured for receiving the signals.

8. The receiver of claim 7, wherein the processing engine comprises a channel selector configured for selecting components of the determined codes from signals selected for energy reduction.

9. The receiver of claim 8, wherein the processing engine is further configured to generate a cancellation operator used to substantially reduce the energy of the signals selected for energy reduction.

10. The receiver of claim 9, wherein the cancellation operator comprises a projection operator Pₛ^{⊥}having the following form:
Pₛ^{⊥}=I−S(S^{T}S)⁻¹S^{T},
where I is an identity/matrix, S is the matrix and S^{T} is a transpose of the matrix.

11. The receiver of claim 10, wherein the processing engine comprises an application unit configured for applying the projection operator Pₛ^{⊥}to a desired code x to selectively substantially reduce one or more of the plurality of signals, wherein the projection operator Pₛ^{⊥}is applied to the desired code according to the following form:
Pₛ^{⊥}x=(I−S(S^{T}S)⁻¹S^{T})x.

12. The receiver of claim 1, wherein the determined codes are selected from a group consisting of a spreading code and a covering code.

13. The receiver of claim 12, wherein the spreading code is a short code.

14. The receiver of claim 12, wherein the covering code is selected from a group consisting of a Walsh code and a quasi orthogonal function code.

15. The receiver of claim 1, wherein the signals are selected from a group consisting of cdma2000 signals and cdmaOne signals.

16. A method for reducing interference to a desired signal, comprising:
determining a code from each of a plurality of signals;
generating a matrix of one or more vectors based on determined codes, wherein each element of the vectors comprises a component of the determined codes; and
using the matrix to selectively substantially reduce energy from one or more of the signals thereby reducing interference.

17. The method of claim 16, further comprising demodulating one or more signals from said plurality of signals.

18. The method of claim 16, further comprising determining one or more codes of signals selected said plurality of signals.

19. The method of claim 16, wherein generating comprises constructing the matrix from one composite interference vector having one or more elements, wherein each element of the vector includes a component of a determined code and a relative amplitude of one of the signals associated with the determined code.

20. The method of claim 16, wherein generating comprises constructing the matrix from a plurality of said vectors, wherein each vector of the matrix has one or more elements, each element comprising a component of a determined code associated with one of the plurality of signals.

21. The method of claim 16, wherein using the matrix comprises generating a cancellation operator for application to a desired code to substantially reduce the energy of the signals selected for energy reduction.

22. The method of claim 21, wherein generating the cancellation operator comprises generating a projection operator Pₛ^{⊥}having the following form:
Pₛ^{⊥}=I−S(S^{T}S)⁻¹S^{T},
where I is an identity matrix, S is the matrix and S^{T} is a transpose of the matrix.

23. The method of claim 22, further comprising applying the projection operator Pₛ^{⊥}to the desired code to selectively substantially reduce one or more of the plurality of signals, wherein the projection operator Pₛ^{⊥}is applied to the desired code according to the following form:
Pₛ^{⊥}x=(I−S(S^{T}S)⁻¹S^{T})x,
where x is the desired code.

24. A system for reducing interference to a desired signal, comprising:
means for determining a code from each of a plurality of signals;
means for generating a matrix of one or more vectors based on determined codes, wherein each element of the vectors comprises a component of the determined codes; and
means for using the matrix to selectively substantially reduce energy from one or more of the signals thereby reducing interference.

25. The system of claim 24, further comprising means for demodulating one or more signals from said plurality of signals.

26. The system of claim 24, further comprising means for determining one or more codes of signals selected from said plurality of signals.

27. The system of claim 24, wherein the means for generating comprises means for constructing the matrix from one composite interference vector having one or more elements, wherein each element of the vector includes a component of a determined code and a relative amplitude of one of the signals associated with the determined code.

28. The system of claim 24, wherein the means for generating comprises means for constructing the matrix from a plurality of said vectors, wherein each vector of the matrix has one or more elements, each element comprising a component of a determined code associated with one of the plurality of signals.

29. The system of claim 24, wherein the means for using the matrix comprises means for generating a cancellation operator for application to a desired code to substantially reduce the energy of the signals selected for energy reduction.

30. The system of claim 29, wherein the means for generating the cancellation operator comprises means for generating a projection operator Pₛ^{⊥}having the following form:
Pₛ^{⊥}=I−S(S^{T}S)⁻¹S^{T},
where I is an identity matrix, S is the matrix and S^{T} is a transpose of the matrix.

31. The system of claim 30, further comprising means for applying the projection operator Pₛ^{⊥}to the desired code to selectively substantially reduce one or more of the plurality of signals, wherein the projection operator Pₛ^{⊥}is applied to the desired code according to the following form:
Pₛ^{⊥}x=(I−S(S^{T}S)⁻¹S^{T})x,
where x is the desired code.

32. A processing engine, comprising:
a matrix generator configured for generating a matrix having one or more vectors, wherein the matrix is generated based on a plurality of codes and wherein each element of the vectors comprises a component of the codes; and
an application unit communicatively coupled to the matrix generator and configured for using the matrix to selectively substantially cancel one or more of a plurality of signals.
